(19) United States
(12) Patent Application Publication
(10) Pub. No.: US 2011/0159824 A1
(43) Pub. Date: Jun. 30, 2011

(54) ACTIVE ANTENNA ARRAY FOR A MOBILE COMMUNICATIONS NETWORK EMPLOYING A FIRST CONDUCTIVE LAYER AND A SECOND CONDUCTIVE LAYER

(76) Inventor: Peter Kenington, Chepstow (GB)

(21) Appl. No.: 12/650,709

(22) Filed: Dec. 31, 2009

(51) Int. Cl. H04B 1/38

(52) U.S. Cl. 455/90.2

(57) ABSTRACT

The present disclosure relates to an active antenna array for a mobile communications network. The active antenna array comprises a plurality of antenna elements, at least one first conductive sheet and at least one second conductive sheet. The plurality of antenna elements terminates at least one relay path. The at least one first conductive sheet comprises at least a portion of the at least one relay path. The at least one second conductive sheet comprises at least one DC voltage path and is at least partially disposed over the first conductive sheet. The present disclosure teaches an implementation of the active antenna array using a (single) multilayer printed circuit board (PCB).

### CROSS-REFERENCE TO RELATED APPLICATIONS

This application is related to U.S. patent application Ser. No. 12/562,313 filed on 18 Sep. 2009 entitled “Power distribution for an array of active electronic circuits in an antenna” which is incorporated herein in its entirety

### FIELD OF THE INVENTION

The field of the invention relates to an active antenna array for a mobile communications network.

### BACKGROUND OF THE INVENTION

The use of mobile communications networks has increased over the last decade. Operators of the mobile communications networks have increased the number of base stations in order to meet an increased request for service by users of the mobile communications networks. The operators of the mobile communications networks wish to reduce the running costs of the base station. It is one option to implement the radio system as an antenna-embedded radio forming an active antenna array. The antenna-embedded radio may be implemented on one or more chips, at least for some of the components of the antenna embedded radio. The antenna embedded radio reduces the space needed to house the hardware components of the base station. Power consumption during normal operation of the active antenna array is reduced when implementing the active antenna array on the one or more chips.

FIG. 1 shows an example of an active antenna array 1a of the prior art. The active antenna array 1a of the prior art comprises transceiver boards TRx-1, TRx-2, . . . TRx-M. In FIG. 1 sixteen of the transceiver boards TRx-1, TRx-2, . . . TRx-M are shown as a non-limiting example. Power distribution is achieved to the transceiver boards TRx-1, TRx-2, . . . TRx-M using a “star” topology, i.e. a pair of wires (positive and ground) is connected from the power supply unit (PSU) 20 to the transceiver boards TRx-1, TRx-2, . . . TRx-M, individually. For sixteen transceiver boards TRx-1, TRx-2, . . . TRx-M sixteen pairs of (relatively high-current) wires are required. The high-current wire is typically flexible and therefore requires insulating throughout its length. The insulation will add to weight and cost of the active antenna array 1a. Since each pair of wires is individually insulated, it occupies more space and adds weight relative to a bus-bar approach outlined below. Typically the number of transceiver boards TRx-1, TRx-2, . . . TRx-M matches the number of antenna elements Ant-1, Ant-2, . . . , Ant-N. Nevertheless there may be more than one antenna element Ant-1, Ant-2, . . . , Ant-N (not shown) terminating an individual relay path pertaining to an individual one of the transceiver boards TRx-1, TRx-2, . . . TRx-M.

Lower voltages are typically generated locally on the individual transceiver boards TRx-1, TRx-2, . . . TRx-M. A motivation for locally generating lower voltages lies in a reduction of the wires and connectors within the active antenna system 1a. As a trade off the locally generated voltages at the transceiver boards TRx-1, TRx-2, . . . TRx-M will increase complexity of the individual transceiver board TRx-1, TRx-2, . . . TRx-M. Local generation of the lower voltages improves redundancy and removes a single point of failure should, for example, the lower voltage generation subsystems of the PSU 20 fail. Such lower voltage subsystems of the PSU 20 can be omitted if the required lower voltages are generated locally on the transceiver boards. The teachings of the present disclosure enable the redundancy and removal of the single point of failure at lower cost than solutions known in the prior art. The teachings of the present disclosure also enable the removal of the multiple wires and connectors required for power distribution within the active antenna array, thereby saving both weight and cost of the complete array.

Digital input signals reach digital circuits 12. The digital circuits 12 comprise digital signal conditioning elements, digital predistortion elements, digital upconversion elements, filters and the like. The digital circuits 12 are part of the relay path reaching individual ones of the transceiver boards TRx-1, TRx-2, . . . TRx-M. The relay path comprises a plurality of low-speed digital lines 14a-1, 14a-2, . . . , 14a-M and a plurality of high-speed digital lines 14b-1, 14b-2, . . . , 14b-M. The low-speed digital lines 14a-1, 14a-2, . . . , 14a-M forward a low-speed digital signal between the digital circuits 12 and an individual one of the transceiver boards TRx-1, TRx-2, . . . TRx-M. The low-speed digital lines 14a-1, 14a-2, . . . , 14a-M may be used for providing control signals to elements in the individual relay path. The individual relay path further comprises a plurality of high-speed digital lines 14b-1, 14b-2, . . . , 14b-M. The high-speed digital lines 14b-1, 14b-2, . . . , 14b-M offer a higher sampling rate than the low-speed digital lines 14a-1, 14a-2, . . . , 14a-M. The high-speed digital lines 14b-1, 14b-2, . . . , 14b-M connect the digital circuit stage 12 to the individual ones of the transceiver boards TRx-1, TRx-2, . . . , TRx-M thereby forming a high-speed portion of the individual relay path.

In the prior art there are a large number of wires of varying types and gauges present in the active antenna array 1a, including those provided for power supply distribution, as discussed earlier. The teachings of this disclosure enable the elimination of some, or all of the wires. It will be appreciated that it is conceivable to replace the transceiver boards as described in FIG. 1 by receiver boards TRx-1, TRx-2, . . . , TRx-M or transmitter boards for the active antenna array 1a without detracting from the invention. The description in the present disclosure uses the example of a transmit-receive active antenna array 1 for simplicity.

### SUMMARY OF THE INVENTION

The present disclosure relates to an active antenna array for a mobile communications network. The active antenna array comprises a plurality of antenna elements, at least one first conductive sheet and at least one second conductive sheet. The plurality of antenna elements terminates at least one relay path. The at least one first conductive sheet comprises at least a portion of the at least one relay path. The at least one second conductive sheet comprises at least one DC voltage path. The at least one second conductive sheet is at least partially disposed over the first conductive sheet.

The term “disposed over” as used herein shall be construed as follows: A first object shall be considered disposed over a second object if at least one position exists from where the first object appears over the second object, when viewed from the at least one position. The term “disposed over” used herein does not require the first object and the second object to be in direct contact with each other. There may be an empty space between the first object and the second object. The space between the first object and the second object may be partially filled with a substance, for example, a substrate, but is not limited thereto. The first object and the second object may be in direct contact when the first object is disposed over the second object. It is further to be understood that for the first object disposed over the second object, it is also correct that the second object is disposed over the first object. The term disposed over merely describes a spatial relationship between the first object and the second object.

### BRIEF DESCRIPTION OF THE DRAWINGS

FIG. 1 shows an active antenna array of the prior art

FIG. 2 shows an example of the active antenna array

FIG. 3 shows a cross-section of the active antenna array

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

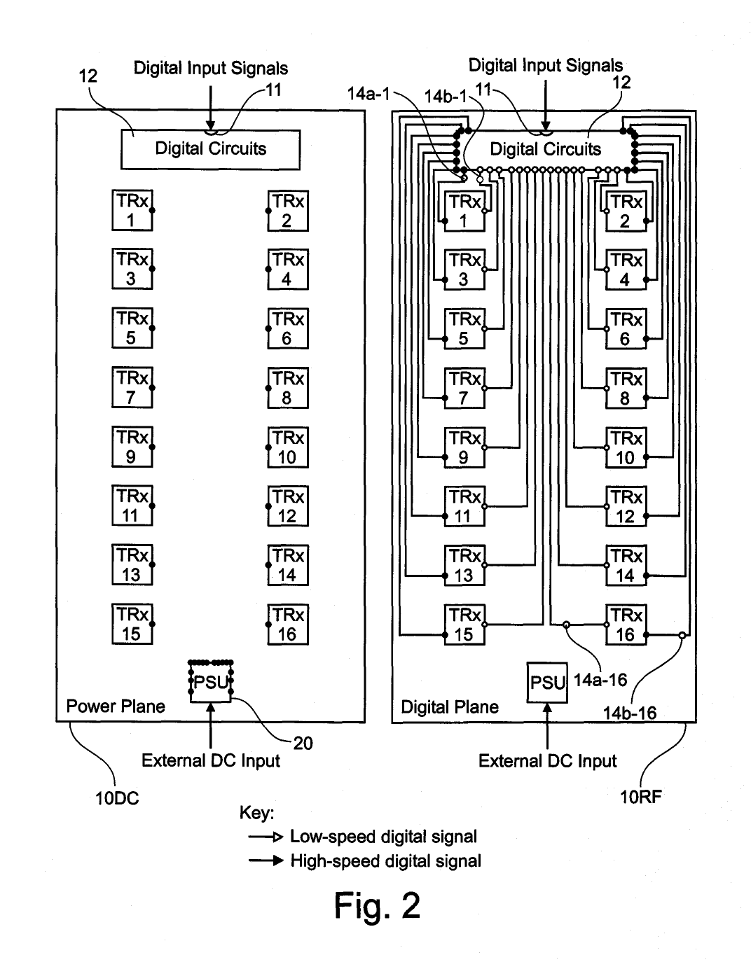

FIG. 2 shows one aspect of a (single) printed circuit board (PCB) used for power and signal distribution in the active antenna array 1.

The active antenna array 1 comprises a first conductive sheet 10RF for a distribution of digital signals at least along a portion of one or more relay paths. The first conductive sheet 10RF is shown in a right half of FIG. 2. There may be more than one first conductive sheet 10RF. The active antenna array 1 further comprises a second conductive sheet 10DC. The second conductive sheet 10DC is used for a distribution of DC voltages in the active antenna array 1. The first conductive sheet 10RF and the second conductive sheet 10DC may be implemented as individual layers of the multilayer PCB. The second conductive sheet 10DC may comprise a DC path along which an individual DC voltage is present.

The relay paths of the active antenna array 1 comprise one or more individual elements of an individual relay path. The individual elements comprise, but are not necessarily limited to, the digital circuits 12, the low-speed digital lines 14a-1, 14a-2, . . . , 14a-M, the high-speed digital lines 14b-1, 14b-2, . . . , 14b-M, filtering elements, signal processing elements, predistortion elements, crest-factor reduction elements, beamforming elements, upconversion and downconversion elements and the individual transceiver boards TRx-1, TRx-2, . . . , TRx-M. The low-speed digital lines 14a-1, 14a-2, . . . , 14a-M provide a connection between the elements of the individual relay paths. The high-speed lines 14b-1, 14b-2, . . . , 14b-M also provide a connection between the individual ones of the elements.

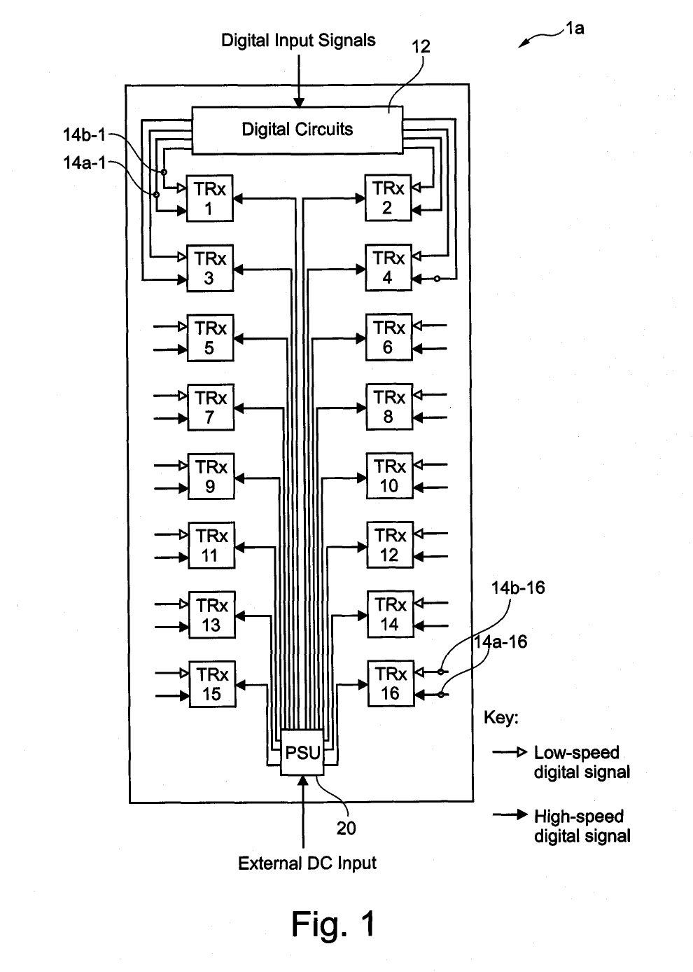

FIG. 2 is a very simplified figure, with only the connections shown in FIG. 1 being included.

FIG. 2 shows (in the left half) a replacement of high-current connections, shown in black in FIG. 1, with a solid conductive power plane forming the second conductive sheet 10DC. The elements of the relay path requiring a DC voltage are connected to the second conductive sheet 10DC. Use of a solid (or substantial, hatched) power plane as the second conductive sheet 10DC ensures that resistance between the PSU 20 and the individual elements, for example, the transceiver boards TRx-1, TRx-2, . . . , TRx-M is minimized, without the need for thick cables or thick PCB tracks.

Likewise, the right-hand side of FIG. 2 shows that the wired digital connections of FIG. 1 have been replaced by PCB tracks on the first conductive sheet 10RF. The PCB tracks comprise the low-speed digital lines 14a-1, 14a-2, . . . , 14a-M and the high-speed digital lines 14b-1, 14b-2, . . . , 14b-M but are not limited thereto. The PCB tracks will have a carefully-defined length, which is determined by design and can experience a minimal thermal expansion, by careful choice of PCB materials. The carefully-defined length in turn simplifies, or possibly eliminates, the need for calibration (other than on manufacture, perhaps). There may be more than one of the first conductive sheets 10RFas will be understood.

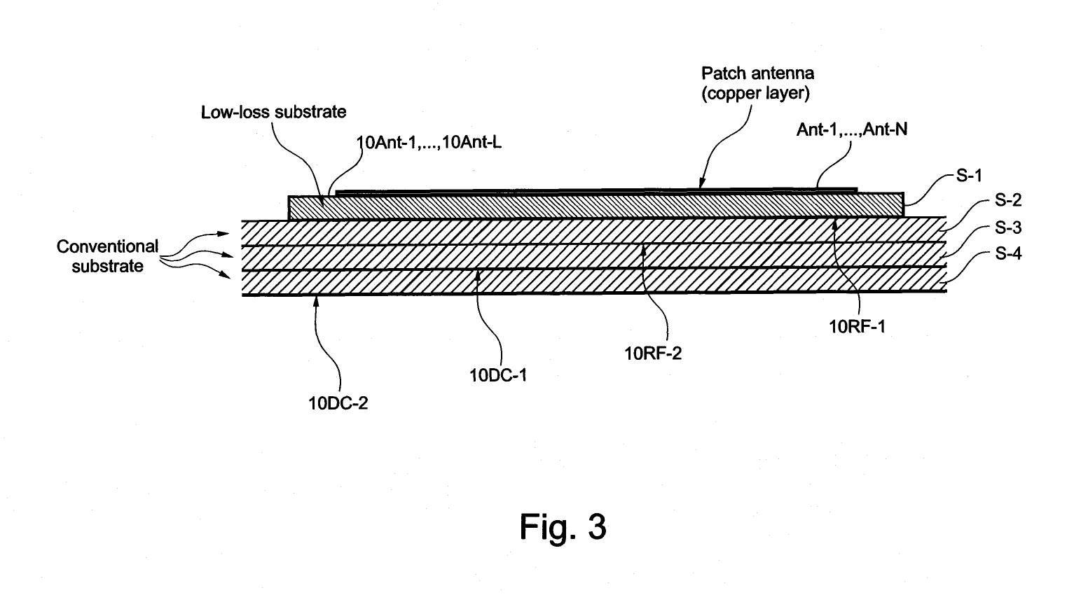

The high-speed digital lines 14b-1, 14b-2, . . . , 14b-M are part of the relay path pertaining to an individual one of the transceiver boards TRx-1, TRx-2, . . . , TRx-M. Likewise the low-speed digital lines 14a-1, 14a-2, . . . , 14a-M form part of the relay paths to the individual ones of the transceiver boards TRx-1, TRx-2, . . . , TRx-M. The transceiver boards TRx-1, TRx-2, . . . , TRx-M are connected to the antenna elements Ant-1, Ant-2, . . . , Ant-N (see FIG. 3) terminating the relay paths of the active antenna array 1. Typically an individual antenna element Ant-1, Ant-2, . . . , Ant-N will terminate an individual relay path. It is nevertheless conceivable for a plurality of antenna elements Ant-1, Ant-2, . . . , Ant-N to terminate an individual one of the relay paths; for example, if more than one of the antenna elements Ant-1, Ant-2, . . . , Ant-N are coupled to the individual transceiver boards TRx-1, TRx-2, . . . , TRx-M.

The digital circuits 12, as one example of the elements of the relay path, also need a connection to the second conductive sheet 10DC-1, 10DC-2, . . . , 10DC-K (shown in a left part of FIG. 2). There may be more than one second conductive sheet 10DC to provide several values of DC voltages, but this is not shown on the Fig. Should there be more than one value of DC voltage, the digital circuits 12 may require a connection to several DC voltage paths provided by the more than one second conductive sheet 10DC. The several DC voltages comprise the ground, positive or negative of the PSU 20, but are not limited thereto. It is also possible to provide multiple tracks or conductive regions formed from a single second conductive sheet 10DC, to distribute all of the multiple voltages which may be required in the active antenna array 1.

The digital circuits 12 include a port 11 for digital input signals. The port is a digital port, for example interfacing with a fiber-optic cable carrying digital signals. The port 11 receives the digital input signals typically provided at digital baseband. It is further possible that the port 11 receives the signals at an intermediate frequency band. The second port 11 may receive the digital input signals on an open base station architecture initiative (OBSAI) format or a common public radio initiative (CPRI) format or a public open baseband remote-radio-head interface (P-OBRI) format, but is not limited thereto. Active electronics, at least partially implemented in the digital circuits 12, perform operations on the digital signals including, but not limited to: crest factor reduction, beamforming, predistortion, upconversion/downconversion to/from radio frequency, power amplification etc. The digital circuits 12 are known in the art and shall not be discussed further. The active electronics may be as well implemented as part of the transceiver boards TRx-1, TRx-2, . . . , TRx-M.

It is to be noted that the low-speed digital lines 14a-1, 14a-2, . . . , 14a-M and/or the high-speed digital lines 14b-1, 14b-2, . . . , 14b-M forward transmit and/or receive signals in a digital format between the transceiver boards TRx-1, TRx-2, . . . , TRx-M and the digital circuits 12. A digital to analogue conversion and/or analogue to digital conversion is performed by the transceiver boards TRx-1, TRx-2, . . . , TRx-M connected to one or more of the antenna elements Ant-1, Ant-2, . . . , Ant-N (see FIG. 3). The first conductive sheet 10RF provide the low-speed digital lines 14a-1, 14a-2, . . . , 14a-M and/or the high-speed digital lines 14b-1, 14b-2, . . . , 14b-M. The transceiver boards TRx-1, TRx-2, . . . , TRx-M will comprise appropriate connections to the first conductive sheet 10RF in order to provide connections as depicted on the right hand side of FIG. 2.

Methods for providing the connections from the first conductive sheet 10RF and/or the second conductive sheets 10DC to the individual elements of the relay path are known in the art and comprise plated through holes and/or vias but are not limited thereto.

It will be noted that the first conductive sheet 10RF is not connected to the PSU 20. Conversely on the second conductive sheet 10DC (left side of FIG. 2) there is no connection from the transceiver boards TRx-1, TRx-2, . . . , TRx-M to the low-speed digital lines 14a-1, 14a-2, . . . , 14a-M and/or the high-speed digital lines 14b-1, 14b-2, . . . , 14b-M and/or the digital circuits 12 other than a connection to provide DC power to the transceiver boards TRx-1, TRx-2, . . . , TRx-M and the digital circuit 12.

FIG. 3 shows an example of a cross-sectional view of the active antenna array 1, a first substrate S-1 is disposed in connection with the antenna element Ant-1, Ant-2, . . . , Ant-N. The first substrate S-1 used in connection with the antenna elements Ant-1, Ant-2, . . . , Ant-N may be selected as a low-loss RF material PTFE. It will be noted that with the active antenna array 1 as shown in FIG. 3 the antenna elements Ant-1, Ant-2, . . . , Ant-N form part of a multilayered PCB. The antenna elements Ant-1, Ant-2, . . . , Ant-N are implemented using a third conductive sheet 10Ant. There may be one or more third conductive sheets 10Ant. For example, each one of the antenna elements Ant-1, Ant-2, . . . , Ant-N may be implemented as a separate third conductive sheet 10Ant.

It will be appreciated that the low-loss RF first substrate S-1 is typically expensive. Therefore it may be of interest to use the first substrate S-1 only for those areas covered by the antenna elements Ant-1, Ant-2, . . . , Ant-N and/or an RF power amplifier circuitry. Nevertheless it is conceivable for the substrate S-1 to extend over substantially the same dimensions, for example, as the first conductive sheet 10RF forming an RF ground plane.

It is further conceivable to use a differing dielectric constant for the substrate S-1 than that used for the remaining substrates, S-2, S-3, S-4 etc. to alter the physical size of the antenna elements Ant-1, Ant-2, . . . , Ant-N. The altered physical size of the antenna elements Ant-1, Ant-2, . . . , Ant-N may be of interest to fit with a mechanical outline desired for the active antenna array 1.

In FIG. 3 a second substrate S-2 is shown in contact with the RF ground plane provided by a first one of the first conductive sheet 10RF-1. The second substrate S-2 separates a second one of the first conductive sheet 10RF-2 from the first conductive sheet 10RF-1. The second one of the first conductive sheet 10RF-2 may be used as a signal track layer carrying for example the low-speed digital lines 14a-1, 14a-2, . . . , 14a-M and/or the high-speed digital lines 14b-1, 14b-2, . . . , 14b-M.

A third substrate S-3 separates the signal track layer from the second conductive sheet 10DC providing the power plane as discussed with respect of the left half of FIG. 2. A fourth substrate S-4 separates a first one of the second conductive sheet 10DC-1 from a second one of the second conductive sheet 10DC-2. The second one of the second conductive sheet 10DC-2 forms a power ground plane.

The first substrate S-1, the second substrate S-2, the third substrate S-3 and the fourth substrate S-4 may comprise an individual substrate material for each of the substrates or an identical substrate material for the substrates S-1, S-2, S-3, S-4. One of the substrates S-1, S-2, S-3, S-4 may comprise one or more substrate materials.

It will be noted that the number of layers of the PCB, i.e. the first conductive sheet 10RF, the second conductive sheet 10DC and the third conductive sheet 10Ant, as shown in FIG. 3, are provided by way of an example only. In practice fewer or a plurality of signal layers, i.e. a plurality of the first conductive sheets 10RF may be provided. Likewise additional power layers, i.e. second conductive sheets comprising the DC voltage paths may be provided.

In another aspect of the active antenna array 1 the external casing of the active antenna array 1, which is often fabricated from aluminium, is used as the negative or ground distribution mechanism. This will result in only a power plane being required, which could distribute either a positive or a negative DC voltage, and a saving in PCB fabrication costs, due to the saving of one layer. Such an aspect of an active antenna array 1 is described in an earlier patent application of the applicant U.S. Ser. No. 12/562,313 filed on 18 Sep. 2009 entitled “Power distribution for an array of active electronic circuits in an antenna” which is incorporated herein in its entirety.

It will be noted that the present disclosure was explained using the example of a (single) multilayered printed circuit board (PCB) providing the first conductive sheet 10RF and the second conductive sheet 10DC and/or the third conductive sheet 10Ant. It may be of interest to provide the conductive sheets grouped into logical subunits, for example comprising an individual relay path or a subset of the relay paths. The providing of the conductive sheets grouped into individual or logical subsets may increase a level of redundancy and remove a potential of single points of failure. Without the grouping into subunits, the complete PCB may need to be replaced, because, for example, one of the transceiver boards TRx-1, TRx-2, . . . , TRx-M is faulty. Methods for subdividing the PCBs using connectors and the like are known in the art.

While various embodiments of the present invention have been described above, it should be understood that they have been presented by way of example, and not limitation. It will be apparent to persons skilled in the relevant arts that various changes in form and detail can be made therein without departing from the scope of the invention.

### REFERENCE NUMERALS

1 active antenna array
Ant-1, Ant-2, . . . , Ant-N antenna elements
10RF-1, 10RF-2, . . . , 10RF-J first conductive sheet
10DC-1, 10DC-2, . . . , 10DC-K second conductive sheet
10Ant-1, 10Ant-2, . . . , 10Ant-L third conductive layer
S-1, S-2, . . . , S-F substrate
TRx-1, TRx-2, . . . , TRx-M transmit-receive module
14a-1, 14a-2, . . . , 14a-M low-speed digital lines
14b-1, 14b-2, . . . , 14b-M high-speed digital lines

1. Active antenna array for a mobile communications network, the active antenna array comprising:
a plurality of antenna elements terminating at least one relay path;
at least one first conductive sheet comprising at least a portion of the at least one relay path;
at least one second conductive sheet comprising at least one DC voltage path and being at least partially disposed over the first conductive sheet.

2. The active antenna array according to claim 1, wherein the at least one DC voltage path provides at least one DC voltage to at least one element of the at least one relay path by at least one connection between the at least one first conductive sheet and the at least one element of the at least one relay path.

3. The active antenna array according to claim 2, wherein the portion of the at least one relay path provides a connection between different ones of the at least one element of the at least one relay path.

4. The active antenna array according to claim 1, further comprising:
at least one third conductive sheet comprising at least one antenna element.

5. The active antenna array according to claim 4, the at least one third conductive sheet being disposed over at least one of the at least one first conductive sheet or the at least one second conductive sheet.

6. The active antenna array according to claim 1, wherein at least one of the at least one first conductive sheet, the at least one second conductive sheet and the at least one third conductive sheet are in contact with a substrate.

7. The active antenna array according to claim 3, wherein at least two of the first conductive sheet, the second conductive sheet and the third conductive sheet are implemented as individual layers in a multilayered printed circuit board.

8. The active antenna array according to claim 1, wherein the at least one first conductive sheet, the at least one second conductive sheet and the at least one third conductive sheet are manufactured from different substrate materials.

9. The active antenna array according to claim 1, wherein the at least one element of the at least one relay path comprises at least one of: a transceiver module, an amplifier, a digital/analogue converter, an analogue/digital converter, an up-converting unit, a down-converting unit, a filtering unit, a digital signal processor.

10. The active antenna array according to claim 2, wherein the at least one second conductive sheet comprises a common ground to selected ones of the at least one element of the at least one relay path.

11. The active antenna array according to claim 1, wherein the at least one first conductive sheet comprises a first plurality of low-speed digital lines connecting digital circuits to the at least one relay path.

12. The active antenna array according to claim 1, wherein the first conductive sheet comprises a second plurality of high-speed digital lines connecting the digital input stage to the at least one relay path.
